(19) United States
(12) Patent Application Publication
(10) Pub. No.: US 2020/0164853 A1
(43) Pub. Date: May 28, 2020

(54) SYSTEM AND METHOD FOR CHANGING DRIVING MODE OF GREEN CAR

(71) Applicants: Hyundai Motor Company, Seoul (KR); KIA Motors Corporation, Seoul (KR)

(72) Inventors: Hui Un SON, Suwon-si (KR); Sung Bae JEON, Ansan-si (KR); Jin Kyeom CHO, Suwon-si (KR)

(21) Appl. No.: 16/402,123

(22) Filed: May 2, 2019

(30) Foreign Application Priority Data
Nov. 28, 2018 (KR) 10-2018-0149086

(51) Int. Cl. B60W 20/00

(52) U.S. Cl. CPC B60W 20/00; B60W 2510/244; B60Y 2300/91; B60Y 2200/92; B60Y 2200/91

(57) ABSTRACT

A system for changing a driving mode of an eco-friendly vehicle is provided, which includes a driving mode strategy establishment unit, an expected charging amount calculation unit, and an available charging amount calculation unit, wherein the driving mode strategy establishment unit establishes a driving mode strategy for each section of the vehicle based on an available charging amount, and if a first charging amount of the vehicle at a charging point is larger than a predetermined maximum charging amount during the established driving mode, the driving mode strategy establishment unit reestablishes the driving mode strategy for each section of the vehicle after deriving a second charging amount through correction of the first charging amount.

### CROSS REFERENCE TO RELATED APPLICATION

The present application claims priority of Korean Patent Application No. 10-2018-0149086 filed on Nov. 28, 2018, the entire contents of which is incorporated herein for all purposes by this reference.

### BACKGROUND

### Field

The present disclosure relates to a system and a method for changing a driving mode of a green car.

### Description of the Related Art

There are various types of hybrid vehicles. In one implementation, a hybrid vehicle has three driving modes, which include an electric vehicle (EV) driving mode (in which the vehicle is driven by a motor using a high voltage battery, a charge driving mode (in which the vehicle is driven by an engine, while charging a battery), and a battery maintaining driving mode (in which the vehicle is driven by the engine and the motor, while maintaining the battery at a predetermined level). In another implementation, a hybrid vehicle may include an electric vehicle mode and a hybrid mode. The vehicle changes its driving mode between the electric vehicle mode and the hybrid mode based on the charging amount or state of charge (SOC) of the vehicle.

### SUMMARY

One aspect of the present disclosure provides a system and a method for changing a driving mode of an eco-friendly vehicle, which can improve the overall fuel economy by changing the driving mode more efficiently through establishment of a driving mode changing strategy with reflection of a charging amount at a charging station.

Another aspect of the invention provides a system for changing a driving mode of an eco-friendly vehicle may include a driving mode strategy establishment unit configured to establish a driving mode strategy for each section of the vehicle based on information about a distance from a current location of the vehicle to a charging point, a charging amount of the vehicle, and a driving load condition of the vehicle; an expected charging amount calculation unit configured to calculate an expected charging amount based on charging information at the charging point; and an available charging amount calculation unit configured to calculate an available charging amount by adding an initial charging amount of the vehicle and the expected charging amount to each other, wherein the driving mode strategy establishment unit establishes the driving mode strategy for each section of the vehicle based on the available charging amount, and if a first charging amount of the vehicle at the charging point is larger than a predetermined maximum charging amount during the established driving mode for each section, the driving mode strategy establishment unit reestablishes the driving mode strategy for each section of the vehicle after deriving a second charging amount through correction of the first charging amount.

The second charging amount may not exceed the predetermined maximum charging amount.

The driving mode strategy establishment unit may be configured to calculate a charging amount to be consumed in a section before the charging point based on mathematical expression 1 below if the first charging amount is larger than the predetermined maximum charging amount.

SOC_{section1}=SOC_{available}−SOC_{Max} [Mathematical expression 1]

where, SOC_{section1} means the charging amount to be consumed in the section before the charging point, SOC_{available} means the available charging amount, and SOC_{Max} means the predetermined maximum charging amount.

The driving mode strategy establishment unit may reestablish a driving mode changing strategy for each section in the section before the charging point based on the charging amount to be consumed in the section before the charging point.

The driving mode strategy establishment unit may reestablish a driving mode changing strategy for each section in the section after the charging point based on the corrected second charging amount.

The driving mode may include an electric vehicle mode and a hybrid mode.

The charging information at the charging point may include a charging power of a charging station at the charging point and a charging time of the charging station.

Still another aspect of the invention provides a method for changing a driving mode of an eco-friendly vehicle may include receiving an input of a charging point of the vehicle; calculating an expected charging amount based on charging information at the charging point of the vehicle; calculating an available charging amount by adding an initial charging amount of the vehicle and the expected charging amount to each other; establishing a driving mode strategy for each section of the vehicle based on information about the available charging amount, a distance from a current location of the vehicle to the charging point, and a driving load condition of the vehicle; and reestablishing the driving mode strategy for each section of the vehicle after deriving a second charging amount through correction of a first charging amount if the first charging amount of the vehicle at the charging point is larger than a predetermined maximum charging amount during the established driving mode for each section.

The second charging amount may not exceed the predetermined maximum charging amount.

The method may further include calculating a charging amount to be consumed in a section before the charging point based on mathematical expression 1 below if the first charging amount is larger than the predetermined maximum charging amount.

SOC_{section1}=SOC_{available}−SOCₘₐₓ [Mathematical expression 1]

where, SOC_{section1} means the charging amount to be consumed in the section before the charging point, SOC_{available} means the available charging amount, and SOC_{Max} means the predetermined maximum charging amount.

The method may further include reestablishing a driving mode changing strategy for each section in the section before the charging point based on the charging amount to be consumed in the section before the charging point.

The method may further include reestablishing a driving mode changing strategy for each section in the section after the charging point based on the corrected second charging amount.

The driving mode may include an electric vehicle mode and a hybrid mode.

A further aspect of the invention provides a method of operating a hybrid vehicle, in which the method includes planning driving mode changes of a hybrid vehicle from a departure location to a destination. Specifically, the method comprises: receiving an input of a battery charging station of the vehicle; estimate a state of charge (SOC) amount to be added at the charging station based on information of capacity of the charging station and time for charging at the station; calculating an expected total SOC by adding an initial SOC of the vehicle and the estimated SOC at the station; establishing a driving mode strategy for the route to get the charging station based on information about the expected total SOC, the maximum allowable SOC of the vehicle, a distance from a current location of the vehicle to the charging station, and a driving load condition of the vehicle; if the expected total SOC is greater than the maximum allowable SOC, establishing the driving mode strategy for the route after the charging station based on the maximum allowable SOC of the vehicle, a distance from the charging station to the destination, and a driving load condition of the vehicle.

According to embodiments disclosed herein, if the first charging amount of the vehicle at the charging point is larger than the predetermined maximum charging amount during the driving mode for each section of the vehicle established based on the available charging amount, the first charging amount is corrected to the second charging amount, and then the optimum driving mode changing strategy for each section is reestablished in the sections before and after the charging point based on the corrected charging amount. Accordingly, the overall fuel economy and merchantability of the vehicle can be improved.

### BRIEF DESCRIPTION OF THE DRAWINGS

The above and other aspects, features and advantages of the present disclosure will be more clearly understood from the following detailed description taken in conjunction with the accompanying drawings, in which:

FIG. 1 is a block diagram illustrating the configuration of a system for changing a driving mode of an eco-friendly vehicle according to an embodiment of the present disclosure;

FIG. 2 is a diagram explaining establishment of a driving mode strategy for each section based on an available charging amount calculated through addition of an initial charging amount and an expected charging amount in a system for changing a driving mode of an eco-friendly vehicle according to an embodiment of the present disclosure;

FIG. 3 is a diagram explaining correction of a charging amount of a vehicle in a system for changing a driving mode of an eco-friendly vehicle according to an embodiment of the present disclosure;

FIG. 4 is a diagram explaining reestablishment of a driving mode strategy for each section of a vehicle based on a corrected second charging amount in a system for changing a driving mode of an eco-friendly vehicle according to an embodiment of the present disclosure; and

FIG. 5 is a flowchart illustrating a method for changing a driving mode of an eco-friendly vehicle according to an embodiment of the present disclosure.

### DESCRIPTION OF EMBODIMENTS

Embodiments of the invention are now described with reference to the accompanying drawings. The terminology used in the description presented herein is not intended to be interpreted in any limited or restrictive manner, simply because it is being utilized in conjunction with a detailed description of certain embodiments of the invention.

In driving a hybrid vehicle, the vehicle changes its driving mode between an electric vehicle mode and a hybrid mode based on the charging amount or state of charge (SOC) of the vehicle. If the driving mode is changed based only on the charging amount, however, the driving mode is changed to a hybrid mode after the entire amount charged in the battery is consumed in an electric vehicle mode regardless of the driving condition of the vehicle. In this case, if high-speed or high-load driving occurs in a section in which the vehicle is driving in the electric vehicle mode, inefficient driving cannot be avoided.

In addition, in the hybrid vehicle, since a driving mode changing strategy is established based on the assumption that charging is performed by 100% in a destination or a gateway, the driving mode changing strategy is established such that the charging amount is consumed by 100% when the vehicle arrives at the destination or the gateway. In this case, however, if the battery is not charged by 100% at the destination or the gateway, it may not be possible to efficiently change the driving mode.

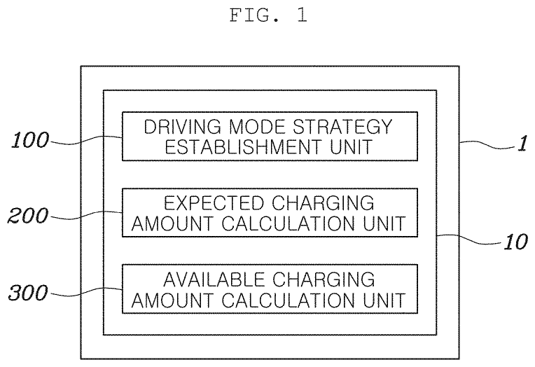

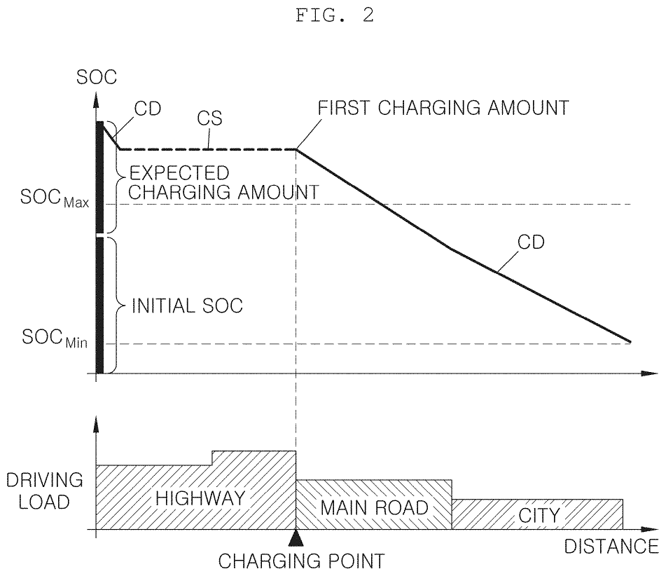

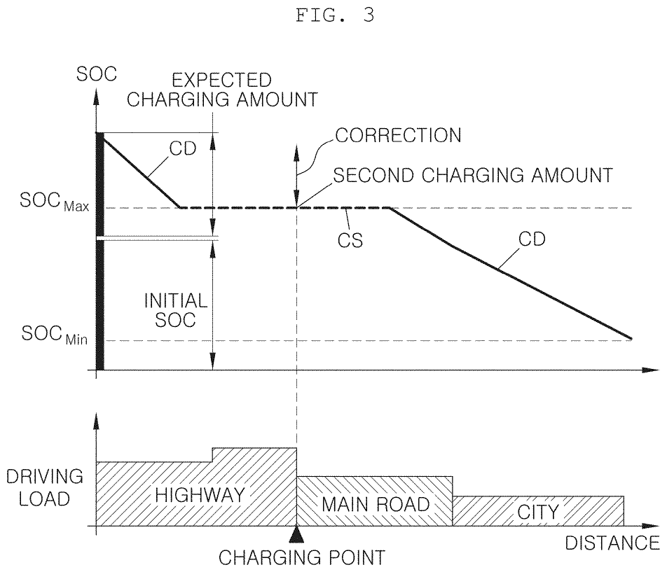

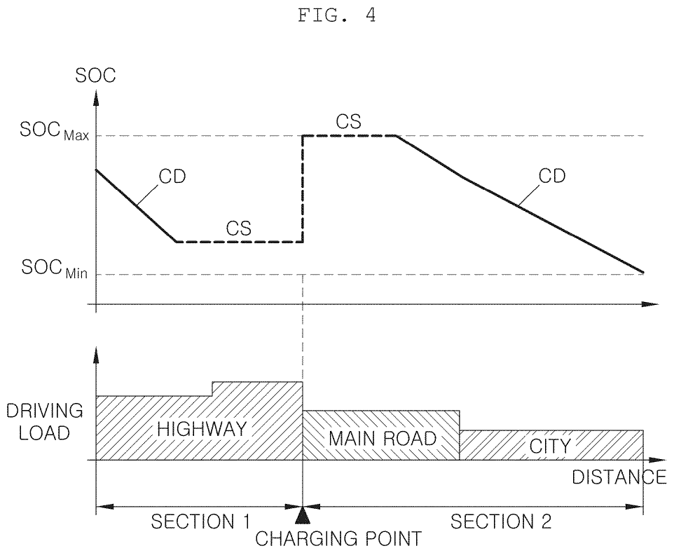

FIG. 1 is a block diagram illustrating the configuration of a system for changing a driving mode of an eco-friendly vehicle according to an embodiment of the present disclosure, and FIG. 2 is a diagram explaining establishment of a driving mode strategy for each of the vehicle's route sections based on an available charging amount calculated through addition of an initial charging amount and an expected charging amount in a system for changing a driving mode of an eco-friendly vehicle according to an embodiment of the present disclosure. FIG. 3 is a diagram explaining correction of a charging amount of a vehicle in a system for changing a driving mode of an eco-friendly vehicle according to an embodiment of the present disclosure, and FIG. 4 is a diagram explaining reestablishment of a driving mode strategy of the vehicle for each section based on a corrected second charging amount in a system for changing a driving mode of an eco-friendly vehicle according to an embodiment of the present disclosure. Throughout the drawings, CD refers to an electric vehicle mode or electric vehicle driving mode, and CS refers to a hybrid mode or hybrid vehicle driving mode.

As illustrated in FIG. 1, a system 10 for changing a driving mode of an eco-friendly vehicle according to an embodiment of the present disclosure is a system mounted on an eco-friendly vehicle 1, and may be configured to include a driving mode strategy establishment unit 100, an expected charging amount calculation unit 200, and an available charging amount calculation unit 300.

The driving mode strategy establishment unit 100 serves to establish a driving mode strategy of the vehicle for each section of the road that the vehicle drives based on information about a distance from a current location of the vehicle to a charging point, a charging amount of the vehicle, and a driving load condition of the vehicle. In embodiments, the charging point may be a gateway or the final destination in which a charging station for charging electric vehicles is installed and which is set through a navigation device or the like before the departure of the vehicle. For example, the charging point may be a resting place in which the charging station is installed. In addition, the driving load condition may include types of roads on which the vehicle is driven. For example, on highway for high-speed driving, the driving load may be relatively high in comparison to that on city roads, and as described above, the driving mode strategy establishment unit 100 may establish the driving mode strategy of the vehicle for each of the vehicle's route sections in consideration of the driving load condition which may differ depending on the type of the road on which the vehicle is driven.

The expected charging amount calculation unit 200 may calculate an expected charging amount based on charging information at the charging point. In embodiments, the charging information at the charging point may include a charging power of a charging station at the charging point and a charging time of the charging station. In embodiments, the expected charging amount calculation unit 200 may calculate the expected charging amount by multiplying the charging power at the charging point by the charging time.

In this case, the charging power information of the charging station in the charging point may be information pre-stored in a server or the like in association with the navigation, and if a user sets the corresponding charging point as a gateway through the navigation, the charging power information of the corresponding charging station can be provided from the server.

In addition, if an expected rest time is input in a state where, for example, Busan is set as the final destination and a resting place for charging electric vehicles is set as a gateway before the departure from Seoul, the charging time may be the expected rest time. Further, for example, if the expected charging amount calculation unit 200 is in association with user's Google Calendar, and driver's schedule and location are input to the expected charging amount calculation unit 200, it becomes possible to derive the expected charging time based on schedule information, such as the Google Calendar. Further, for example, if the corresponding vehicle is a rental car through a car sharing system, the expected charging time can be derived based on the expected return time of the current vehicle driver and the rental start time of the next vehicle driver.

The available charging amount calculation unit 300 may calculate an available charging amount by adding an initial charging amount of the vehicle and the expected charging amount calculated through the expected charging amount calculation unit 200 to each other.

On the other hand, as illustrated in FIG. 2, the driving mode strategy establishment unit 100 may establish the driving mode strategy for each section of the vehicle's route based on the available charging amount calculated by the available charging amount calculation unit 300. Specifically, referring to FIG. 2, it can be known that a first charging amount of the vehicle at the charging point is larger than the predetermined maximum charging amount in sections for respective driving modes established based on the available charging amount. In this case, the predetermined maximum charging amount may be the maximum charging amount allowed by a high-voltage battery mounted on the vehicle. If the first charging amount of the vehicle at the charging point is larger than the predetermined maximum charging amount in the sections for the respective driving modes established based on the available charging amount, the driving mode strategy establishment unit 100 may derive a second charging amount through correction of the first charging amount, and may reestablish the driving mode strategy for each section based on the derived second charging amount. In this case, the corrected second charging amount may not exceed the predetermined maximum charging amount.

More specifically, if the first charging amount of the vehicle at the charging point is larger than the predetermined maximum charging amount as shown in FIG. 2 in the sections for the respective driving modes of the vehicle established based on the available charging amount, the driving mode strategy establishment unit 100 may correct the first charging amount to the second charging amount as illustrated in FIG. 3. In addition, if the first charging amount is larger than the predetermined maximum charging amount, the driving mode strategy establishment unit 100 may calculate the charging amount to be consumed in the section before the charging point based on mathematical expression 1 below.

SOC_{section1}=SOC_{available}−SOCₘₐₓ [Mathematical expression 1]

where, SOC_{section1} means the charging amount to be consumed in the section before the charging point, SOC_{available} means the available charging amount, and SOC_{Max} means the predetermined maximum charging amount.

Further, the driving mode strategy establishment unit 100 may reestablish a driving mode changing strategy for each section in the section before the charging point based on the charging amount to be consumed in the section before the charging point calculated through mathematical expression 1.

In addition, the driving mode strategy establishment unit 100 may reestablish the driving mode changing strategy for each section in the section after the charging point based on the corrected second charging amount. In the present disclosure, the driving mode may include an electric vehicle mode and a hybrid mode. In this case, the electric vehicle mode (CD) may mean a state where a vehicle on which a motor and an engine are mounted is driven by the motor only, and the hybrid mode (CS) may mean a state where the vehicle is driven by the motor and the engine.

FIG. 4 is a diagram explaining a case where if the first charging amount of the vehicle at the charging point is larger than the predetermined maximum charging amount as shown in FIG. 2 during the driving mode for each section established based on the available charging amount, the driving mode strategy establishment unit 100 derives the second charging amount through correction of the first charging amount, and then reestablishes the driving mode changing strategy for each section in the sections before and after the charging point. Like this, according to the present disclosure, if the first charging amount of the vehicle at the charging point is larger than the predetermined maximum charging amount during the driving mode for each section established based on the available charging amount, the first charging amount is corrected to the second charging amount, and then the optimum driving mode changing strategy for each section is reestablished in the sections before and after the charging point based on the corrected charging amount. Accordingly, the overall fuel economy and merchantability of the vehicle can be improved.

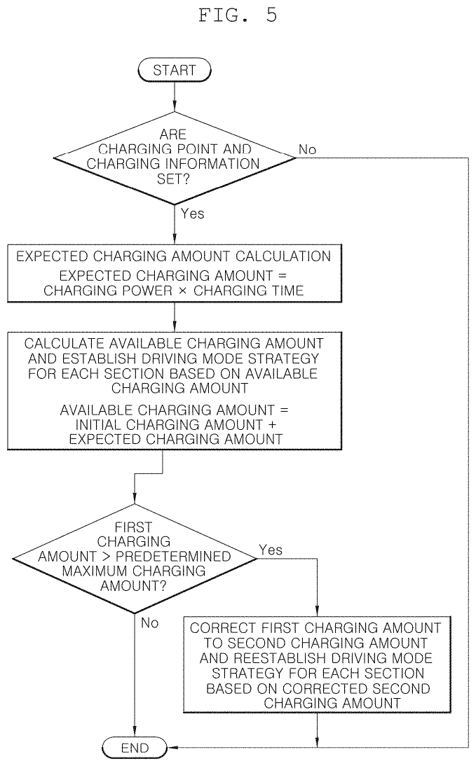

FIG. 5 is a flowchart illustrating a method for changing a driving mode of an eco-friendly vehicle according to an embodiment of the present disclosure. Referring to FIG. 5, a method for changing a driving mode of an eco-friendly vehicle according to an embodiment of the present disclosure will be described. The method for changing a driving mode of an eco-friendly vehicle using a system for changing a driving mode of an eco-friendly vehicle may include receiving an input of a charging point of the vehicle, calculating an expected charging amount based on charging information at the charging point of the vehicle, calculating an available charging amount by adding an initial charging amount of the vehicle and the expected charging amount to each other, establishing a driving mode strategy for each section of the vehicle's route based on information about the available charging amount, a distance from a current location of the vehicle to the charging point, and a driving load condition of the vehicle, and reestablishing the driving mode strategy for each section of the vehicle's route after deriving a second charging amount through correction of a first charging amount if the first charging amount of the vehicle at the charging point is larger than a predetermined maximum charging amount during the established driving mode for each section. In embodiments, the second charging amount does not exceed the predetermined maximum charging amount.

In addition, the method may further include calculating a charging amount to be consumed in a section before the charging point based on mathematical expression 1 below if the first charging amount is larger than the predetermined maximum charging amount.

SOC_{section1}=SOC_{available}−SOCₘₐₓ [Mathematical expression 1]

where, SOC_{section1} means the charging amount to be consumed in the section before the charging point, SOC_{available} means the available charging amount, and SOC_{Max} means the predetermined maximum charging amount.

Further, the method may further include reestablishing a driving mode changing strategy for each section in the section before the charging point based on the charging amount to be consumed in the section before the charging point, and reestablishing the driving mode changing strategy for each section in the section after the charging point based on the corrected second charging amount. Here, the driving mode may include an electric vehicle mode and a hybrid mode. In this case, the electric vehicle mode may mean a state where a vehicle on which a motor and an engine are mounted is driven by the motor only, and the hybrid mode may mean a state where the vehicle is driven by the motor and the engine.

Logical blocks, modules or units described in connection with embodiments disclosed herein can be implemented or performed by a computing device having at least one processor, at least one memory and at least one communication interface. The elements of a method, process, or algorithm described in connection with embodiments disclosed herein can be embodied directly in hardware, in a software module executed by at least one processor, or in a combination of the two. Computer-executable instructions for implementing a method, process, or algorithm described in connection with embodiments disclosed herein can be stored in a non-transitory computer readable storage medium.

Although embodiments of the present disclosure have been illustrated and described for illustrative purposes, those of ordinary skill in the art will appreciate that various modifications, additions and substitutions are possible, without departing from the scope and spirit of the invention as disclosed in the accompanying claims.

What is claimed is:

1. A system for changing an eco-friendly vehicle's driving mode, comprising:
a driving mode strategy establishment unit configured to establish a driving mode strategy of the vehicle for each section based on information about a distance from a current location of the vehicle to a charging point, a charging amount of the vehicle, and a driving load condition of the vehicle;
an expected charging amount calculation unit configured to calculate an expected charging amount based on charging information at the charging point; and
an available charging amount calculation unit configured to calculate an available charging amount by adding an initial charging amount of the vehicle and the expected charging amount to each other,
wherein the driving mode strategy establishment unit is configured to establish the driving mode strategy of the vehicle for each section based on the available charging amount, and if a first charging amount of the vehicle at the charging point is larger than a predetermined maximum charging amount during the established driving mode for each section, the driving mode strategy establishment unit reestablishes the driving mode strategy for each section of the vehicle after deriving a second charging amount through correction of the first charging amount.

2. The system according to claim 1, wherein the second charging amount does not exceed the predetermined maximum charging amount.

3. The system according to claim 1, wherein the driving mode strategy establishment unit is configured to calculate a charging amount to be consumed in a section before the charging point based on mathematical expression 1 below if the first charging amount is larger than the predetermined maximum charging amount.
SOC_{section1}=SOC_{available}−SOCₘₐₓ [Mathematical expression 1]
where, SOC_{section1} means the charging amount to be consumed in the section before the charging point, SOC_{available} means the available charging amount, and SOC_{Max} means the predetermined maximum charging amount.

4. The system according to claim 3, wherein the driving mode strategy establishment unit is configured to reestablish a driving mode changing strategy for each section in the section before the charging point based on the charging amount to be consumed in the section before the charging point.

5. The system according to claim 1, wherein the driving mode strategy establishment unit is configured to reestablish a driving mode changing strategy for each section in the section after the charging point based on the corrected second charging amount.

6. The system according to claim 1, wherein the vehicle comprises at least two driving modes which include an electric vehicle mode and a hybrid mode.

7. The system according to claim 1, wherein the charging information at the charging point comprises a charging power of a charging station at the charging point and a charging time of the charging station.

8. A method of changing an eco-friendly vehicle's driving mode using the system for changing a driving mode of an eco-friendly vehicle of claim 1, comprising:
receiving an input of a charging point of the vehicle;
calculating an expected charging amount based on charging information at the charging point of the vehicle;
calculating an available charging amount by adding an initial charging amount of the vehicle and the expected charging amount to each other;
establishing a driving mode strategy of the vehicle for each section based on information about the available charging amount, a distance from a current location of the vehicle to the charging point, and a driving load condition of the vehicle; and
reestablishing the driving mode strategy of the vehicle for each section after deriving a second charging amount through correction of a first charging amount if the first charging amount of the vehicle at the charging point is larger than a predetermined maximum charging amount during the established driving mode for each section.

9. The method according to claim 8, wherein the second charging amount does not exceed the predetermined maximum charging amount.

10. The method according to claim 8, further comprising calculating a charging amount to be consumed in a section before the charging point based on mathematical expression 1 below if the first charging amount is larger than the predetermined maximum charging amount.
SOC_{section1}=SOC_{available}−SOCₘₐₓ [Mathematical expression 1]
where, SOC_{section1} means the charging amount to be consumed in the section before the charging point, SOC_{available} means the available charging amount, and SOC_{Max} means the predetermined maximum charging amount.

11. The method according to claim 10, further comprising reestablishing a driving mode changing strategy for each section in the section before the charging point based on the charging amount to be consumed in the section before the charging point.

12. The method according to claim 8, further comprising reestablishing a driving mode changing strategy for each section in the section after the charging point based on the corrected second charging amount.

13. The method according to claim 8, wherein the vehicle comprises at least two driving modes that comprise an electric vehicle mode and a hybrid mode.
